(19) United States
(12) Patent Application Publication
(10) Pub. No.: US 2025/0021232 A1
(43) Pub. Date: Jan. 16, 2025

(54) METHOD TO IMPLEMENT A REDUNDANT ARRAY OF INDEPENDENT DISKS WITH HIGH CAPACITY SOLID STATE DRIVES

(71) Applicant: Netlist, Inc., Irvine, CA (US)

(72) Inventor: Junkil RYU, Irvine, CA (US)

(73) Assignee: Netlist, Inc., Irvine, CA (US)

(21) Appl. No.: 18/349,455

(22) Filed: Jul. 10, 2023

(51) Int. Cl. G06F 3/06

(52) U.S. Cl. CPC G06F 3/0613; G06F 3/064; G06F 3/0689

(57) ABSTRACT

A system can include a host computer system and a host system bus coupled to the host computer system. One or more storage devices can be coupled to the host system bus and configured to store data. Additionally, a computational storage device (CSD) can be coupled to the host system bus and configured to receive a data write request comprising data from the host computer system. The CSD can further include a memory and an application processor. The application processor of the CSD can be configured to write the data of the data write request to the one or more storage devices in response to receiving the data write request.

### TECHNICAL FIELD

The present disclosure relates to computer storage systems, and more particularly, to redundant arrays of storage devices.

### BACKGROUND

A redundant array of independent disks (RAID), sometimes called a redundant array of inexpensive disks, is a data storage virtualization technology that combines multiple physical disk drive components into one or more logical units for the purposes of data redundancy and/or performance improvement. Data is distributed across the drive components in one of several ways, referred to as RAID levels, depending on the required amount of redundancy and performance.

Drive components can include hard disk drives (HDD) and solid state drives (SDD). Currently, the maximum capacity of a serial advanced technology attachment (SATA) HDD is 20 terabytes (TB) and the maximum capacity of a Non-Volatile Memory Express (NVMe) SSD is 30 TB. Most of the current SATA HDDs support 7200 rotations per minute and have a maximum sustained transfer rate below 300 megabytes (MB) per second.

A RAID controller, sometimes called a disk array controller, is a device that manages the drive components and presents them to a computer system as logical units. A RAID controller can further provide a back-end interface that communicates with controlled storage devices (i.e., disks) and a front-end interface that communicates with a computer's host adapter (e.g., a Host Bus Adapter (HBA). The back-end interface usually uses a protocol such as Parallel Advanced Technology Attachment (PATA), SATA, Small Computer System Interface (SCSI), Fibre Channel (FC), or Serial Attached SCSI (SAS). The front end-interface also uses a protocol, such as ATA, SATA, or SCSI.

Conventionally, a RAID controller receives a data write request from a host system via a host system bus. The RAID controller can further configure storage volumes in a plurality of storage devices, such as solid state drives (SSDs), in response or prior to receiving the data write request. In response to receiving the data write request, the RAID controller can perform a parity calculation to determine a parity block and determine data placement of the parity bit and data provided by the data write request among the storage volumes.

The maximum total input/output (I/O) bandwidth of a fourth generation Peripheral Component Interconnect Express (PCIe) RAID controller that has sixteen bus lanes is 32 gigabytes per second (GB/s). A fifth generation PCIe (PCIe 5.0) RAID controller that has sixteen bus lanes has a maximum I/O bandwidth of 64 GB/s. In an example, the RAID controller is coupled to a storage system that includes ten fourth generation PCIe (PCIe 4.0) Non-Volatile Memory Express (NVMe) solid state drives (SSDs) that each have four bus lanes. Accordingly, the ten PCIe 4.0 NVMe SSDs can provide 80 GB/s of bandwidth to the host system. However, the RAID controller is limited to 32 GB/s, such that 48 GB/s of bandwidth of the PCIe 4.0 NVMe SSDs is wasted by the RAID controller. That is, the RAID controller curtails performance of the storage system by introducing a bandwidth bottleneck between the host system bus and the storage system.

A parity bit, or check bit, is a bit added to a string of binary code. Parity bits are a simple form of error detecting code. Parity bits are generally applied to the smallest units of a communication protocol, typically 8-bit octets (bytes), although they can also be applied separately to an entire message string of bits. Parity bits are used to check the integrity of data transfers and can provide indications of errors in said transfers.

### OVERVIEW

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a system can include a host computer system and a host system bus coupled to the host computer system. The system can include one or more storage devices coupled to the host system bus and configured to store data. The system can further include a computational storage device (CSD) coupled to the host system bus and configured to receive a data write request that further includes data from the host computer system. The CSD can further include a memory and an application processor configure to write data of the data write request to the one or more storage devices in response to receiving the data write request.

According to another embodiment consistent with the present disclosure, a system includes a host computer system that includes a host system bus adaptor that allows the host computer system to communicate over a network. The system further includes a host system bus coupled to the host computer system, and can include one or more storage devices coupled to the host system bus to communicate with the host computer system over the network. The system can further include or more storage volumes, each storage volume having memory space partitioned in at least one of the one or more SSDs. Further, the system can include one or more computational storage devices (CSDs) that receive a data write request comprising data from the host computer system, each CSD corresponding to a storage volume of the one or more storage volumes. Each CSD can further include a memory and an application processor that generates a parity block for the data, stripes the data into one or more blocks of data, and stores the parity block and one or more blocks of data in the corresponding storage volume.

According to yet another embodiment consistent with the present disclosure, a method for storing data. The method can include generating, by a host computer system, a first data write request including a first set of data. The method can include providing, via a host system bus, the first data write request to a first computational storage device (CSD). The CSD can include an application and a memory. The method can further include generating, by the first CSD, a first parity block for the first set of data in response to receiving the first data write request. The method can further include striping, by the first CSD, the first set of data into a first set of blocks in response to receiving the first data write request. Further, the method can include storing, by the first CSD, the first parity block and first set of blocks in a first storage volume in response to striping the first set of data. The first storage volume can include one or more storage devices coupled to the host system bus.

According to another embodiment consistent with the present disclosure, a computational storage device (CSD) can include an interface configured to couple the CSD to a host system bus. The CSD can receive a data write request via the interface. The CSD can further include an application processor and a memory. The memory can be configured to store an application program executable by the application processor for calculating a parity block for data of the data write request. The application program can be executable by the application processor for striping the data into a set of blocks, as well as distributing the set of blocks and the parity block across one or more storage devices couple to the host system bus via the interface.

According to yet another embodiment consistent with the present disclosure, a storage system for coupling to a host computer system via host system bus can include one or more storage devices. The storage system can include one or more storage volumes, each storage volume having memory space partitioned in at least one of the one or more storage devices. The storage system can further include one or more computational storage devices (CSDs) configured to receive a data write request comprising data. Each CSD can include an interface configured to couple to the one or more storage devices. Further, each CSD can include a memory configured to storage an application program for generating a parity block for the data, striping the data into one or more blocks of data, and writing the parity block and the one or more blocks of data to a corresponding storage volume. Each CSD can further include an application processor configured to execute the application program.

According to another embodiment consistent with the present disclosure, a storage system can include a plurality of computational storage devices (CSDs). A given CSD can include an interface configured to couple to at least one other CSD and to receive a data write request including data. The given CSD can further include a partitioned memory, wherein a first partition contributes to a first storage volume controlled by the given CSD. A second partition can contribute to a second storage volume controlled by at least one other CSD. The given CSD can further include an application processor configured to execute and application program stored in the memory of the given CSD. The application program can include machine executable instructions for generating a parity block for the data, striping the data into one or more blocks of data, and writing the parity block and the one or more blocks of data to the first storage volume.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram of an example storage system including a computational storage device (CSD);

FIG. 2 is a block diagram of another storage system including a CSD;

FIG. 3 is a block diagram of an example host computer system;

FIG. 4 is a block diagram of an example CSD;

FIG. 5 is a block diagram of another storage system including multiple CSDs;

FIG. 6 is a block diagram of another storage system including multiple CSDs;

FIG. 7 is a flowchart example method for storing data in a storage system including a CSD.

### DESCRIPTION OF EXAMPLE EMBODIMENTS

The present disclosure relates to computer storage systems, and more particularly, to redundant arrays of storage devices. In certain embodiments, the computer storage system employs a computational storage device (CSD) to implement storage policies. In certain embodiments, the implemented policies may correspond in whole or in part to RAID-related policies.

In certain embodiments, to obviate the bandwidth bottleneck from the storage system, the storage devices of the storage system are coupled directly to the host system bus, without using a conventional RAID controller. The storage devices can include solid state devices (SSDs), hard disk drives (HDDs), and computational storage devices (CSDs). Rather than relying on the RAID controller, the CSD can implement or perform storage policies such as parity calculations and determinations of data placement among the storage devices. Furthermore, the CSD itself can include an SSD to build a storage volume of the storage system. Therefore, bandwidth to the host system is not limited to a RAID controller's internal bus (e.g., fourth generation PCIe with four bus lanes) as in conventional arrangements, but is instead a function of the bandwidth of the host systems bus. In certain embodiments, a host system bus can be over a network and include a Fibre Channel that has a bandwidth of 256 GB/s or Transmission Control Protocol/Internet Protocol (TCP/IP) that has a bandwidth of 400 GB/s. Moreover, different configurations of a storage system that includes one or more CSDs can further curtail bandwidth restrictions of the storage system with each CSD managing a storage volume and/or each CSD including an SSD that contributes to the storage volumes.

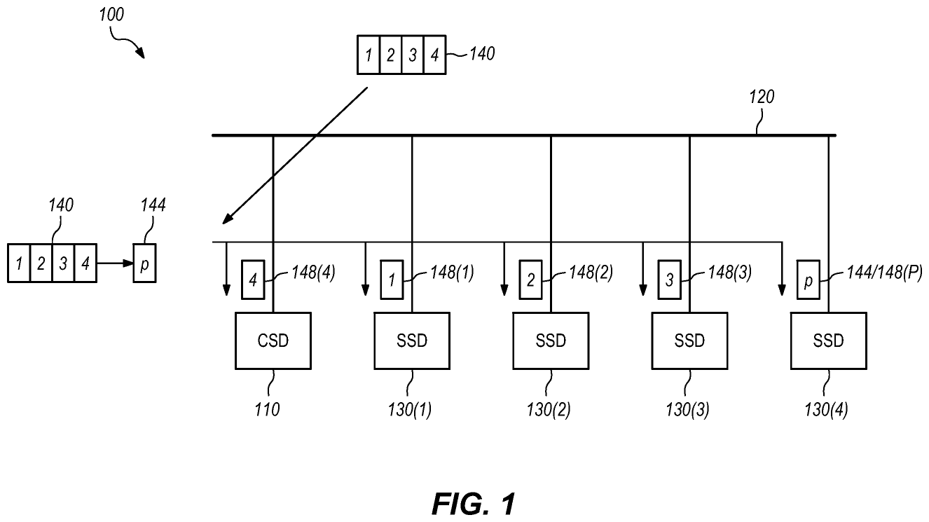

FIG. 1 is a block diagram of an example storage system 100 including a computation storage device (CSD) 110. The storage system 100 can be coupled to a host system (not shown) via a host system bus 120. In an example, the host system bus 120 can be a Peripheral Component Interconnect Express (PCIe) that can include sixteen to eighty or more bus lanes. Moreover, devices of the storage system 100 can be coupled directly to the host system bus 120. In other words, storage devices of the storage system 100 (such as SSDs 130 and CSD 110 discussed below) can have a dedicated connection to the host system bus 120, such that each storage device can be accessed in parallel and operate independently.

The storage devices of the storage system 100 can include the CSD 110, as well as one or more solid state drives (SDDs) 130. In the example illustrated in FIG. 1, the storage system 100 can include four SSDs 130 and the CSD 110, with each of the SSDs 130 and the CSD 110 being coupled directly to the host system bus 120. In some examples, the SSDs 130 can be hard disk drives (HDDs) or other types of storage media, such as . . . . In other examples, the storage devices of the storage system 100 can include a mix of SSDs, HDDs, and/or other storage media. For purposes of simplification, the first SSD 130 that is proximal to the CSD 110 on the host system bus 120 can be referred to as SSD 130(1). Similarly, the second SSD 130 away from the CSD 110 can be referred to as SSD 130(2), the third SSD 130 away from the CSD 110 as SSD 130(3), and the fourth SSD 130 away from the CSD 110 as SSD 130(4). The SSDs can be referred to collectively as SSDs 130 and individually as SSDs 130(1)-130(4). Moreover, the example storage system 100 is not limited to one CSD 110 or four SSDs 130 as both these numbers can be different than set forth herein.

The devices 110, 130 of the storage system 100 can be arranged in an array as shared storage devices. Accordingly, the CSD 110 of the storage system 100 can communicate with the host system, as well as with the SSDs 130, for example via the host system bus 120. Therefore, the CSD 110 can receive a data write, or a read request, from the host system via the host system bus 120 according to the design implementation of the storage system 100. If the CSD 110 handles data placement determination for example, the CSD 110 receives write/read requests. Alternatively, if the CSD 110 performs parity calculations and the host computer system determines data placement, read and write requests can be sent to each of the storage devices. Specifically, the host system can store information related to storage devices belonging to the storage volume. Accordingly, the host system can generate each write or read request and provide the write or read request to each storage device via software of the host system, such as a CSD 110 driver. In other examples, the host system can deliver a volume request to the CSD 110 and the CSD 110 can generate each write/read request to each storage device in response to receiving the volume request.

The data write request can include data 140 that is to be stored among the devices of the storage system, such as the SSDs 130 and/or CSD 110. The data 140 can be referred to as a data chunk. It can be stored by the host computer system and provided to the CSD 110 as a logical sequence, such as a file, array, or data structure that includes a collection of elements that are each identified by an array index. In some examples, the host computer system can determine an address in the devices 110, 130 to store the data 140 and specify the addresses in the data write request. In response to receiving the data 140 of the data write request, the CSD 110 can perform a parity calculation on the data 140. That is, the CSD 110 generates a parity block 144 by performing a parity check on the data 140.

The CSD 110 of the storage system can further perform striping of the data 140. That is, the CSD 110 can separate the data 140 into blocks 148. For example, FIG. 1 illustrates the data 140 as a sequence of four blocks 148, such that the data 140 provided to the CSD 110 can be stored as an array, list, or string. Accordingly, the CSD 110 can stripe the data 140 by separating the data 140 into separate blocks 148—four in this example. For purposes of simplification, the first block 148 striped from the data 140 can be referred to as block 148(1), the second block 148 as block 148(2), the third block 148 as block 148(3), and the fourth block 148 as block 148(4). More or less blocks are possible, depending for example on the number of CSDs 110 and SSDs 110, although one-to-one correspondence of block to storage device is not necessary. In some examples, the CSD 110 can append the calculated parity block 144 to the data 140, such that the parity block 144 can be stored as an additional block “148(P)” in SSD 130(4). Therefore, the blocks can be referred to collectively as blocks 148 and individually as blocks 148(1)-148(4), as well as block 148(P). Further, the CSD 110 can stripe the data 140 in N number of blocks 148, N being an integer greater than zero, such that the blocks 148 can include blocks 148(1)-148(N). Additionally, each block 148 does not have to of the same size or length—that is, the number of bits per block 148 can be more (or less) than one.

The CSD 110 can determine placement of the parity block 144 and blocks 148 across the storage system 100. Specifically, the CSD 110 can determine which storage device of the storage system 100 will store which block 148 of the data 140, as well as the parity block 144/148(P). As illustrated in FIG. 1, block 148(1) can be stored in SSD 130(1). Similarly, block 148(2) can be stored in SSD 130(2) and block 148(3) can be stored in SSD 130(3). The CSD 110 can further determine placement of the parity block 144/148(P) in SSD 130(4), such that the CSD 110 does not have to store the parity block 144 calculated by the CSD 110. Instead, the CSD 110 can store block 148(4).

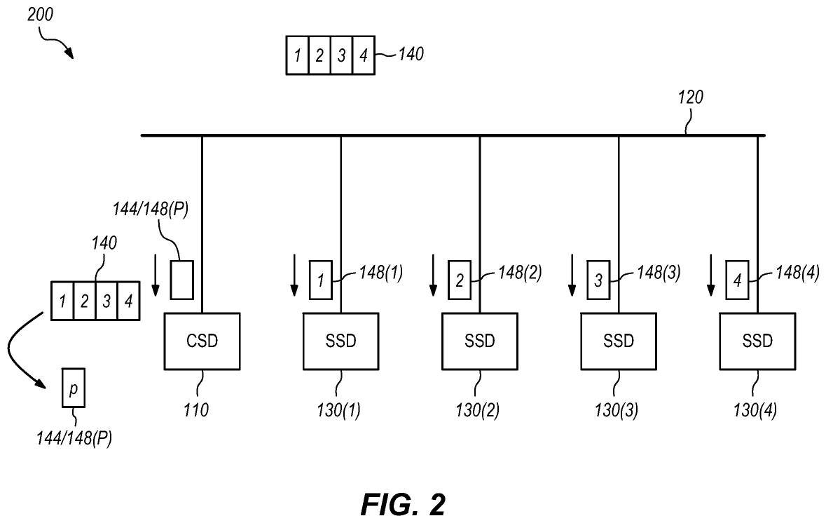

FIG. 2 illustrates another example storage system 200 in accordance with certain embodiments. Similar to storage system 100, storage system 200 can include a CSD 110 and SSDs 130, such as SSDs 130(1)-130(4), although the number of CSDs and SSDs can vary. Again, the CSD 110 can communicate with the host system via the host system bus 120. The CSD 110 can also receive a data write request that includes data 140. The CSD 110 can further calculate the parity block 144 for the data 140, as well as stripe the data 140 into blocks 148(1)-148(N). In this example, the host system (not shown) determines placement of blocks 148(1)-148(N) among the SSDs 130. For example, SSD 130(1) can store block 148(1), SSD 130(2) can store block 148(2), and SSD 130(3) can store block 148(3). In contrast to storage system 100 of FIG. 1, in which the CSD 110 determines placement of blocks 148(1)-148(N), the host system of storage system 200 of FIG. 2 can determine placement of blocks 148(1)-148(N). Further, the CSD 110 of the storage system 100 of FIG. 1 can store block 148(4) and write the parity block 144/148(P) to SSD 130(4), whereas the CSD 110 of storage system 200 of FIG. 2 can store the parity block 144/148(P) and write block 148(4) to SSD 130(4). Moreover, the host system can include an application program that determines placement of the blocks 148 among the storage system 200 and generate a data write request that includes data 140, as well as a data placement determination. Yet, the CSD 110 can still receive data 140 to calculate and generate a parity block 144.

Additionally, the CSD 110 can receive a data write request from the host system to write partial data, such as block 148(1) to SSD 130(4). In some examples, a partial data write request can be made to modify a portion or part of a file to reduce computational overhead, rather than rewriting the entire file. In other examples, writing partial data can allow several partial writes to occur concurrently to enhance performance. Particularly, the CSD 110 can receive a data write request to overwrite data stored on SSD 130(4) (or another SSD or the CSD 110). For example, block 148(4) can be initially stored on SSD 130(4), as illustrated in FIG. 2. In response to receiving a data write request for storing partial data such as block 148(1) to SSD 130(4), the CSD 110 can read block 148(4) from SSD 130(4) to calculate a new parity block 144 with old block 130(4) and new block 148(1) for SSD 130(4) before completing the storage of block 148(1) to SSD 130(4).

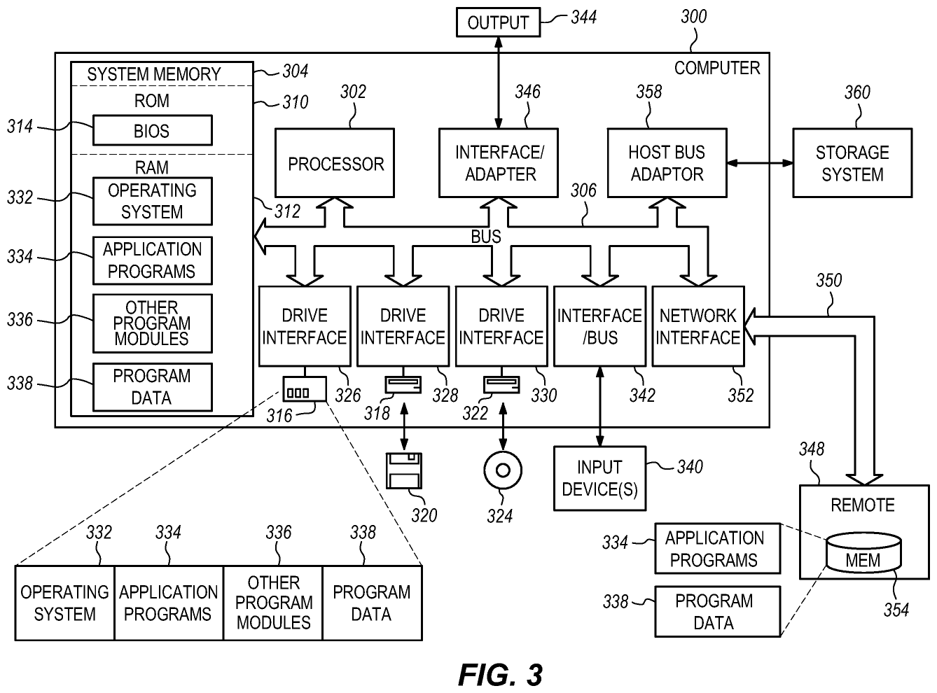

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 3. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 3 illustrates one example of a host computer system 300 that can be employed to execute one or more embodiments of the present disclosure. Host computer system 300 can be implemented on one or more general purpose networked computer systems, embedded computer systems, routers, switches, server devices, client devices, various intermediate devices/nodes or standalone computer systems. Additionally, host computer system 300 can be implemented on various mobile clients such as, for example, a personal digital assistant (PDA), laptop computer, pager, and the like, provided it includes sufficient processing capabilities.

Host computer system 300 includes processing unit 302, system memory 304, and system bus 306 that couples various system components, including the system memory 304, to processing unit 302. System memory 304 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 302. System bus 306 may be any of several types of bus structure including a memory bus or memory controller, a peripheral bus, and a local bus using any of a variety of bus architectures. Further, the system bus 306 can be the host system bus 120 of FIGS. 1 and 2. System memory 304 includes read only memory (ROM) 310 and random access memory (RAM) 312. A basic input/output system (BIOS) 314 can reside in ROM 310 containing the basic routines that help to transfer information among elements within host computer system 300.

Host computer system 300 can include a hard disk drive 316, magnetic disk drive 318, e.g., to read from or write to removable disk 320, and an optical disk drive 322, e.g., for reading CD-ROM disk 324 or to read from or write to other optical media. Hard disk drive 316, magnetic disk drive 318, and optical disk drive 322 are connected to system bus 306 by a hard disk drive interface 326, a magnetic disk drive interface 328, and an optical drive interface 330, respectively. The drives and associated computer-readable media provide nonvolatile storage of data, data structures, and computer-executable instructions for host computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 312, including operating system 332, one or more application programs 334, other program modules 336, and program data 338. In some examples, the application programs 334 can include data placement determination modules and/or policy modules to implement policies, and the program data 338 can include data (e.g., data 140 of FIG. 1) and data placement determinations. The application programs 334 and program data 338 can include functions and methods programmed to generate data write requests that include data and data placement determinations among SSDs (e.g., SSDs 130), such as shown and described herein. The data placement determinations can determine a storage device to store blocks (e.g., blocks 148 of FIG. 1) of data striped from the data and a parity block (e.g., parity block 144 of FIG. 1) based on a configuration of the storage system. Furthermore, the application programs 334 can include driver(s) for the operating system 332 to manage storage devices and data placement using the processing unit 302.

A user may enter commands and information into host computer system 300 through one or more input devices 340, such as a pointing device (e.g., a mouse, touch screen), keyboard, microphone, joystick, game pad, scanner, and the like. For instance, the user can employ input device 340 to edit or modify data write requests, data 140, and/or data/block placement determinations. These and other input devices 340 are often connected to processing unit 302 through a corresponding port interface 342 that is coupled to the system bus, but may be connected by other interfaces, such as a parallel port, serial port, or universal serial bus (USB). One or more output devices 344 (e.g., display, a monitor, printer, projector, or other type of displaying device) is also connected to system bus 306 via interface 346, such as a video adapter.

Host computer system 300 may operate in a networked environment using logical connections to one or more remote computers, such as remote computer 348. Remote computer 348 may be a workstation, computer system, router, peer device, or other common network node, and typically includes many or all the elements described relative to host computer system 300. The logical connections, schematically indicated at 350, can include a local area network (LAN) and/or a wide area network (WAN), or a combination of these, and can be in a cloud-type architecture, for example configured as private clouds, public clouds, hybrid clouds, and multi-clouds. When used in a LAN networking environment, host computer system 300 can be connected to the local network through a network interface or adapter 352. When used in a WAN networking environment, host computer system 300 can include a modem, or can be connected to a communications server on the LAN. The modem, which may be internal or external, can be connected to system bus 306 via an appropriate port interface. In a networked environment, application programs 334 or program data 338 depicted relative to host computer system 300, or portions thereof, may be stored in a remote memory storage device 354.

The host computer system 300 can further include a host bus adaptor (HBA) 358. The HBA 358 can be a circuit board or expansion card that interfaces the host system to external storage, such as a storage system 360. The storage system 360 can be the storage system 100 of FIG. 1 or the storage system 200 of FIG. 2. The HBA 358 can further couple the host computer system 300 to a Storage Area Network (SAN), such that the HBA 358 can provide an interface between a PCIe bus, or system bus 306 of the host computer system 300 to the SAN that includes the storage system 360. Because the system bus 306 is coupled to HBA 358, the host computer system 300 can provide application data, such as data write requests and data placement determinations to the storage system 360 via the HBA 358. Particularly, the data write requests and data 140 can be provided to a CSD, such as CSD 110 of FIGS. 1-2. Moreover, the HBA 358 can store a World Wide Name (WWN) address of each device in the SAN. In an example, ports of storage devices can have a WWN starting with 5 and the HBA 358 and HBAs of other bus adaptors can have a WWN starting with 10.

The SAN can also be deployed with Fibre Channel (FC) connections and protocols, such that the HBA 358 couples to the storage system 360 through interface converters capable of converting digital bits into light pulses for transmission and converting received light pulses into digital bits. That is, the HBA 358 can be an FC HBA. In other examples, the HBA 358 can include an FC HBA and an Ethernet network interface controller (NIC). Therefore, the host computer system 300 can deploy FC over Ethernet (FCoE), such that a 10 Gigabit Ethernet network can be used with FC protocol(s). Additionally, the HBA 358 can enable NVMe over Fabrics (NVMe-OF) protocol over FC or Ethernet.

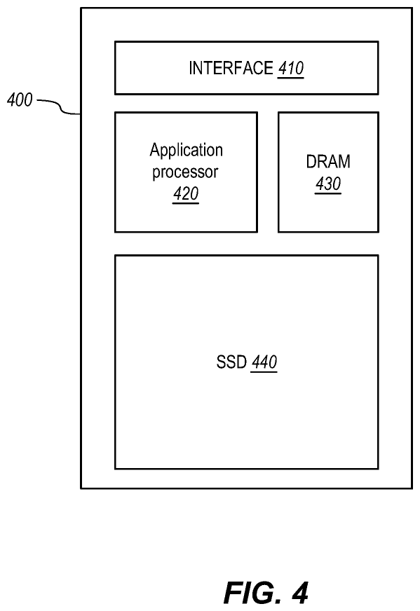

FIG. 4 illustrates an example CSD 400, which can be the CSD 110 of FIGS. 1-2. The CSD 400 can include an interface 410 to couple to the CSD 400 to an SAN, similar to the HBA 358 of FIG. 3. Therefore, the CSD 400 can couple to the host system bus (e.g., system bus 306) via the interface 410. The interface 410 can be configured to couple to the HBA 358 of the host computer system 300 of FIG. 3, such as a converter interface to receive and transmit light impulses across an FC network. The CSD 400 can further have sixteen PCIe bus lanes. In an example, the CSD 400 can have sixteen PCIe 3.0 bus lanes, each PCIe 3.0 bus lane having a bandwidth of 8 GB/s in each direction. Therefore, the CSD with sixteen PCIe 3.0 bus lanes can have a bandwidth of 128 GB/s. In some examples, the CSD 400 can have sixteen PCIe 4.0 bus lanes, each PCIe 4.0 bus lane having a bandwidth of 16 GB/s in each direction. Therefore, the CSD 400 with sixteen PCIe 4.0 bus lanes can have a bandwidth of 256 GB/s. In other examples, the CSD 400 can have sixteen PCIe 5.0 bus lanes, each PCIe 5.0 bus lane having a bandwidth of 32 GB/s in each direction. Therefore, a CSD 400 with sixteen PCIe 5.0 bus lanes can have a bandwidth of 512 GB/s. A CSD 400 can further include sixteen PCIe 6.0 bus lanes, again doubling the bandwidth of the CSD 400 using PCIe 5.0 bus lanes.

An SSD of a storage system, such as SSDs 130 of FIGS. 1-2 can be NVMe SSD. A consumer grade NVMe SSD can use four PCIe 3.0 bus lanes. Therefore a consumer grade NVMe SSD can have a bandwidth of 4 GB/s. Enterprise NVMe SSDs can support more lanes and/or faster bus speeds. For example, an enterprise NVMe SSD can support four PCIe 4.0 bus lanes and have a bandwidth of 8 GB/s, while an enterprise NVMe SSD that supports four PCIe 5.0 bus lanes can have a bandwidth of 16 GB/s. Therefore, the CSD 400 having more bus lanes than SSDs coupled to the CSD 400 can support data transfer to a plurality of SSDs. For example, a CSD 400 that has sixteen PCIe 4.0 bus lanes can transfer data to at least four PCIe 4.0 SSDs.

Referring back to FIGS. 1-2, the CSD 110, such as the CSD 400 of FIG. 4, can be coupled to the host system bus 120 in a manner similar to the SSDs 130. For example, the devices of the storage system including the CSD 110 and SSDs 130 can be coupled to the host computer system (e.g., host computer system 300) in parallel. Storage devices can be coupled to the host computer system in a parallel configuration, which allows for simultaneous data access and operations and provides configurable redundancy and fault tolerance. In other examples, the storage devices can be coupled to the host computer system in “series,” such as a daisy-chain. Although the storage devices can be coupled in series, each storage device can still couple directly to the host system bus 120, which allows for parallel access and operations independent from other storage devices.

Because PCIe is a point-to-point topology, with separate serial links connecting each storage device to the root (e.g., host system), a RAID controller is connected to the host system with the PCIe lanes (×8 or ×16) separately. Therefore, storage devices are connected to the RAID controller under the RAID internal PCIe bus, such that the (external) bus bandwidth of a RAID controller creates a bottleneck. Instead, when using the CSDs 110 and the SSDs 130, the CSDs 110 and SSDs 130 are connected directly to the host computer system 300 which can be utilized fully, thereby obviating the bottleneck created by the RAID controller.

Referring back to FIG. 4, the CSD 400 can further include an application processor 420 that can receive data write requests, data/block placement determinations, and data 140 (FIGS. 1, 2) from the host computer system 300 via the interface 410. The application processor 420 can be an application specific integrated chip (ASIC), microprocessor, or computational processing unit (CPU). The application processor 420 can perform functions in response to receiving a data write request from the host computer system 300. Particularly, the application processor 420 can perform parity calculations for data 140 included with the data write request from the host to generate a parity block 144 (FIGS. 1 and 2).

In some examples, the application processor 420 can further determine data/block placements among a plurality of storage devices of an SAN (e.g., storage systems 100, storage system 200, and/or storage system 360). The application processor 420 can perform parity calculations and determine data/block placements according to an application program stored on dynamic random-access memory (DRAM) 430 of the CSD 400. The application program stored on the DRAM 430 of the CSD 400 can be similar to the application programs 334 and program data 338 of the host computer system 300 of FIG. 3, such that the application program stored on the DRAM 430 can determine data/block placement and store data 140. Moreover, the CSD 400 can perform parity calculations, such that the application program stored on the DRAM 430 can calculate parity blocks from application data, such as data 140. The application program of the CSD 400 can include a policy that aligns with the application program 334 and policies of the host computer system 300 to appropriately store data among storage devices 110 and 130 of a storage system 100 and 200, as well as recover data.

The program data 338 of the host system 300 can include storage device information, such that the application program 334 includes a CSD 400 driver so that the host computer system can map data 140 to storage devices 110 and 130 of the storage system 100 and 200. Accordingly, if the application program 334 of the host computer system 300 has access to mapping information in program data 338, the application program 334 of the host computer system 300 can generate read requests to each storage device 100 and 200 directly. Alternatively, the application program of the CSD 400 can generate read requests to each storage device directly, such that each storage device transfer requested data directly to the host computer system 300.

Additionally, the application programs stored on the DRAM 430 of the CSD 400 can further provide data/blocks, as well as parity block 144 and data blocks 148 to SSDs 130 of a storage system. That is, the CSD 400 can provide the SSDs 130 with the parity block 144 and data blocks 148(1)-148(N) in response to calculating parity and generating the parity block 144. The CSD 400 can further include an SSD 440 to contribute storage functionality to the storage system. That is, the SSD 440 can store a parity block 144, such as the parity block 144 of FIG. 2, and/or one or more data blocks of data blocks 148(1)-148(N), such as block 148(4) of FIG. 1.

Because the CSD 400 can be employed to execute application programs that execute policies, the CSD 400 can replace a RAID controller. That is, the application programs 334 of the host computer system 300 and the application program of the DRAM 430 of the CSD 400 can include RAID related policies to store data among the storage system. However, the CSD 400 does not couple to the host computer system 300 via internal buses, in the manner of a conventional RAID controller. Rather, the CSD can couple to a plurality of SSDs 130 of a storage system 360 via a network (e.g., SAN), thereby removing the bandwidth bottleneck of a RAID controller. In other words, the storage system described herein can leverage the increased bandwidth of a network, such as an FC, rather than be constrained by the limited bandwidth of a RAID controller.

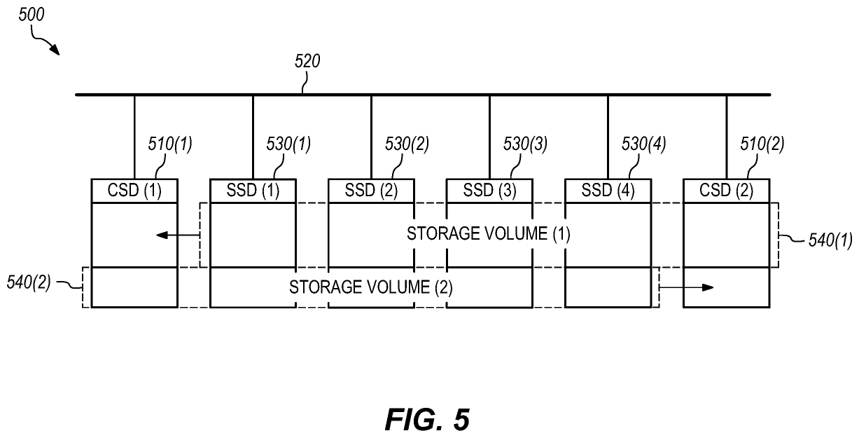

FIG. 5 illustrates an example of another storage system 500 with multiple CSDs 510. The storage system 500 can be coupled to a host system bus 520 (e.g., host system bus 120 of FIGS. 1-2), similar to the storage system 100 of FIG. 1 or storage system 200 of FIG. 2. The storage system 500 can also include one or more SSDs 530, which can be the SSDs 130 of FIGS. 1-2. That is, the SSDs can be referred to collectively as SSDs 530 and individually as SSDs 530(1)-530(4). For purposes of simplification, a first CSD 510 shown proximal to SSD 530(1) can be referred to as CSD 510(1) and a second CSD 510 shown proximal to SSD 530(4) can be referred to as CSD 510(2). Accordingly, the CSDs can be referred to collectively as CSDs 510 or individually as CSD 510(1)-510(2).

Each CSD 510 can be the CSD 110 of FIGS. 1-2 and CSD 400 of FIG. 4, such that each CSD 510 includes an SSD, such as SSD 440 of FIG. 4. Therefore, each CSD 510 can receive data, such as data 140 of FIGS. 1-2. In response to receiving data, the CSD 510 can stripe the data into blocks, such as blocks 148(1)-148(N) of FIGS. 1-2, as well as calculate and generate a parity block, such as parity block 144 of FIGS. 1-2. Accordingly, each CSD 510 and SSD 530 can store a parity block or a block of data.

Furthermore, the CSDs 510 can contribute to one or more storage volumes, such as storage volumes 540(1) and/or 540(2) (collectively 540) of the storage system 500. That is, each storage device of the storage system 500 can be partitioned, such that a partition of each storage device can contribute to a corresponding storage volume 540. When referring to a hard drive or SSD, a partition is a section of the drive that is separated from other segments of the drive. Moreover, each SSD 530, as well as the SSDs of CSDs 510, can be partitioned to include logical divisions that are treated as separate units by the host computer system or CSDs 510. Therefore, each SSD 530(1)-530(4) and SSDs of CSDs 510 can include a partition that corresponds to a storage volume 540. Additionally, each CSD 510(1)-510(2) can configure a storage volume 540 among the SSDs 530 according to a policy and/or based on the configuration of the storage system 500. Multiple such storage volumes 540 can be established in this manner.

As illustrated in FIG. 5, storage volume 540(1) can include a partition of SSDs 530(1)-530(4), as well as CSD 510(2). Moreover, storage volume 540(1) can be controlled by CSD 510(1). That is, the host computer system (e.g., 300 of FIG. 3) or CSD 510(1) can determine placement of data, such as a parity block or block of data across storage volume 540(1). Accordingly, CSD 510(1) can write data to storage volume 540(1) in response to receiving a data write request via the host system bus 520. Additionally, CSD 510(2) can use another partition or namespace of SSDs 530(1)-530(4) to configure another storage volume (2). Therefore, the host computer system or CSD 510(2) can determine placement of data across storage volume 540(2) and CSD 510(2) can write a parity block and data blocks to storage volume 540(2).

In an example, the host computer system can provide a first data write request that includes a first set of data to CSD 510(1). The first set of data can be data 140 of FIG. 1. In response to receiving the first data write request, CSD 510(1) can calculate parity for the first set of data and generate a parity block for the first set of data. Furthermore, CSD 510(1) can stripe the first set of data into a first set of data blocks, the blocks being portions of the first set of data, such as blocks 148(1)-148(N) of FIG. 1. Moreover, CSD 510(1) can store a policy for determining data placement of the first set of blocks and the parity block, such that CSD 510(1) determines placement of the first set of blocks and the parity block. The CSD 510(1) can further store the parity block and first set of blocks in storage volume 540(1). In this example, CSD 510(1) can write the parity block to SSD 530(4) and write the first set of blocks to SSDs 530(1)-530(3) and CSD 510(2).

Additionally, the host computer system can provide a second data write request that includes a second set of data to CSD 510(2), as well as a data placement determination from the host computer system. That is, the host computer system can implement a policy to determine placement of the second set of data and a parity block to be determined by CSD 510(2). The second set of data can be data 140 of FIG. 2. In response to receiving the second data write request, CSD 510(2) can calculate parity for the second set of data and generate the parity block. The CSD 510(2) can further store the parity block and the second set of blocks in storage volume 540(2). Moreover, the parity block calculated for the second set of data can be stored by CSD 510(1) of storage volume 540(2), such as by an SSD of CSD 510(1). Further, storage volume 540(2) of SSDs 530(1)-530(4) can store the second set of blocks striped from the second set of data.

The CSDs 510 (e.g., CSD 400 of FIG. 4 and CSD 110 of FIGS. 1-2) of the storage system 500 remove bottlenecks that can be caused by a RAID controller. For example, as the number of SSDs 530 increases in a given storage system, which is possible because of the ease of scalability of the system, an increased number of CSDs 510 can increase processing power and performance to handle calculations for distributing data across the SSDs 530 and managing storage volumes 540. A RAID controller, by comparison, may not be able to handle additional loads of increased storage, thereby creating a performance bottleneck. As previously discussed, RAID controllers also have bandwidth limitations for data transfer, which further limits overall performance of a given storage system. Although a given CSD 510 can have a higher bandwidth capacity than a RAID controller, additional CSDs 510, 110, 400 (as well as additional SSDs 130, 530 for increased storage capacity) can be added to the system 500 to further contribute to the overall performance of the storage system by providing additional bandwidth. CSDs 510 can introduce multiple control points, such that each CSD 510 can calculate parity blocks, store the parity blocks, and distribute the parity blocks in a corresponding storage volume 540. Therefore, CSDs 510 obviate a need to rely on a RAID controller or a single control point and common data path that limits scalability as PCIe and/or storage upgrades are developed.

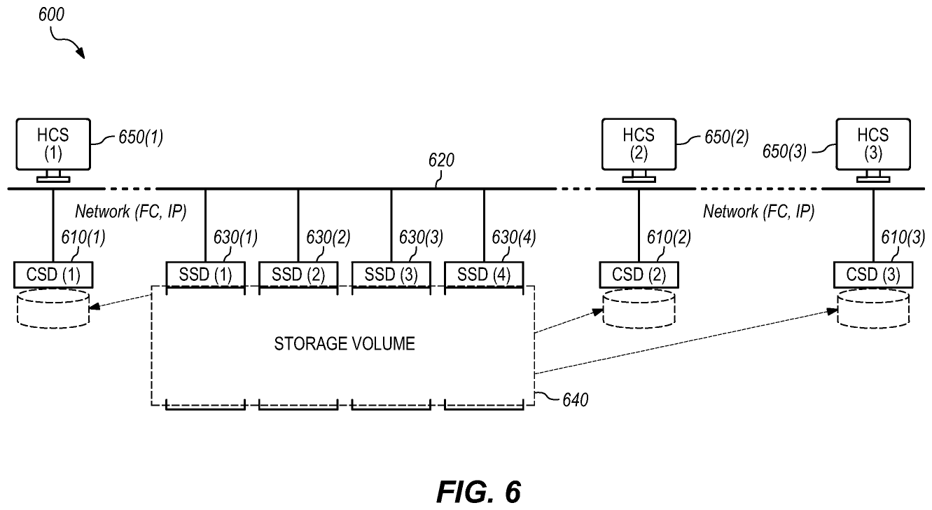

FIG. 6 illustrates another example storage system 600 with multiple CSDs 610, which can be CSDs 510 of FIG. 5, CSD 400 of FIG. 4, and CSD 110 of FIGS. 1-2. Again, the CSDs 610 of the storage system 600 can be coupled to a host system bus 620. The storage system 600 can further have a plurality of SSDs 630 coupled to the host system bus 620, which can be SSDs 130(1)-130(4) of FIGS. 1-2 and 4-5. Again, the SSDs can be referred to collectively as SSDs 630 and individually as SSDs 630(1)-630(4). The CSDs 610 can include CSD 610(1) shown proximal to SSD 630(1) and CSD 610(2) shown proximal to SSD 630(4), similar to FIG. 5. Additionally, storage system 600 can include a third CSD 610, which can be referred to as CSD 610(3). Accordingly, the CSDs can be referred to collectively as CSDs 610 and individually as CSDs 610(1)-610(3).

Similar to SSDs 530 of FIG. 5, SSDs 630 can contribute to a storage volume 640. Although the SSDs 630 can be partitioned to contribute to multiple storage volumes 640, a single storage volume across SSDs 630(1)-630(4) is illustrated for purposes of simplification. Again, the CSDs 610 can each implement policies to store data across the storage volume 640. In this example, the CSDs 610 control, but do not contribute storage capacity to the corresponding storage volume 640. In other examples, one or more of the CSDs 610 can control as well as contribute storage capacity to the corresponding storage volume 640.

In certain embodiments, each CSD 610 is coupled to a corresponding host computer system (HCS) 650 via the host system bus 620. For purposes of simplification, CSD 610(1) can be coupled to HCS 650(1), CSD 610(2) can be coupled to HCS 650(2), and CSD 610(3) can be coupled to HCS 650(3). Accordingly, the HCSs can be referred to collectively as HCSs 650 and individually as HCSs 650(1)-650(3). Each CSD 610 can be coupled to the corresponding HCS 650 via a host bus adaptor (HBA), such as HBA 358 of FIG. 3. Therefore, each CSD 610 can couple to a PCIe bus of the corresponding HCS 650.

Additionally, the plurality of CSDs 610, SSDs 630, and HCSs 650 of the storage system 600 can form a storage area network (SAN). For example, the HBA of HCS 650(1) can couple to the HBA of HCSs 650(2)-650(3) and the CSDs 610, as well as the plurality of SSDs 630. Therefore, each CSD 610(1)-610(3) can communicate with each HCS 650(1)-650(3) and each SSD 630(1)-630(4). The SAN of the storage system 600 can be formed via a physical layer or connection, such as Fibre Channel (FC). Because the CSDs 610 and SSDs 630 can form an SAN, the CSDs 610 and SSDs 630 can appear locally attached to the HCSs 650, such as a local area network (LAN). In alternative examples, the CSDs 610, SSDs 630, and HCSs 650 can communicate over a wireless local area network (WLAN).

In an example, HCS 650(1) can provide a data write request to CSD 610(1). The data write request can include a first set of data, such as data 140 of FIG. 1. The data write request can further include a data placement determination, determined by HCS 650(1). In response to receiving the data write request and the first set of data, CSD 610(1) can calculate and generate a first parity block for the first set of data. Additionally, CSD 610(1) can stripe the first set of data into a first set of blocks. Accordingly, CSD 610(1) can store the first parity block and the first set of blocks in the storage volume 640.

Additionally, conventional RAID controllers implement block storage systems that require additional locking services or file systems to avoid write conflicts by multiple clients or applications. Because the storage system 600 includes multiple CSDs 610, multiple clients (e.g., HCSs 650) or corresponding application programs (e.g., application program 334 of FIG. 3) can read and write to the storage volume 640 without an additional locking mechanism or file system. For example, the storage system 600 includes a plurality of host computer systems 650, such that the HCSs 650 can employ different CSDs 610 to store data in the SSDs 630. That is, HCS 650(2) can provide CSD 610(2) with a second data write request that includes a second set of data, as well as a data placement determination. In response, CSD 610(2) can calculate and generate a second parity block and stripe the second set of data into a second set of blocks. Therefore, CSD 610(2) can store the second parity block and the second set of blocks in the storage volume 640. Accordingly, a plurality of CSDs 610 can be employed to store data provided by multiple applications of different HCSs 650 without requiring additional locking mechanisms or file systems.

Additionally, the host computer systems 650 can employ multiple CSDs 610 to store data. HCS 650(3) can provide a third data write request including a third set of data to CSD 610(2). In response, CSD 610(2) can determine data placement for the third set of data, calculate and generate a third parity block for the third set of data, and stripe the third set of data into a third set of blocks. Thus, CSD 610(2) can store the third parity block and the third set of blocks in storage volume 640.

Moreover, HCS 650(3) can provide a fourth data write request to CSD 610(3). That is, HCS 650(3) can provide the fourth data write request including a fourth set of data and data placement determination to CSD 610(3). In response, CSD 610(3) can calculate and generate a fourth parity block for the fourth set of data and stripe the fourth set of data into a fourth set of blocks. Therefore, CSD 610(3) can store the fourth parity block and fourth set of blocks in storage volume 640. Additionally, CSD 610(3) can store the fourth parity block and fourth set of blocks in the storage volume 640 contemporaneous to CSD 610(2) storing the third parity block and third set of blocks in storage volume 640.

Because a plurality of CSDs 610 can be deployed in the storage system 600 and share SSDs 630 that contribute to respective storage volumes 640, the storage system 600 eliminates bandwidth bottlenecks caused by hardware such as RAID controllers. Rather, a storage system that employs one or more CSDs 610 can leverage increased bandwidth provided by FC, FCoE, and TCP/IP networks. Furthermore, HCSs 650 can work together to expand the number of available PCIe bus lanes, such as by employing PCIe switches. For example, a given HCS 650 can have sixteen to forty PCIe bus lanes, whereas HCS 650(1)-650(3) can work together to provide a host system bus 620 that has eighty or more PCIe bus lanes.

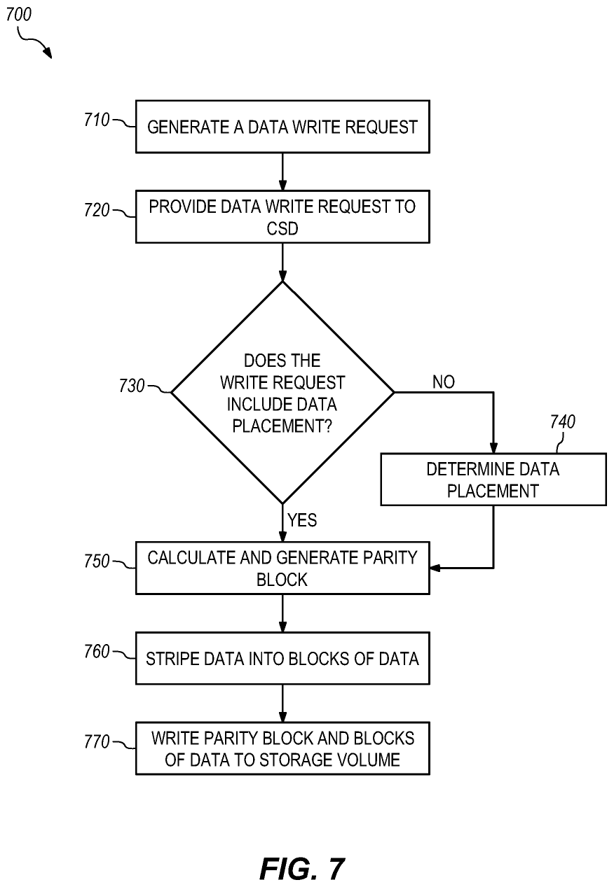

FIG. 7 illustrates a flowchart of an example method 700 for storing data in an example storage system that includes one or more CSDs. The storage system can be storage system 100 of FIG. 1, storage system 200 of FIG. 2, storage system 500 of FIG. 5, or storage system 600 of FIG. 6. At 710, a host computer system, such as host computer system 300 of FIG. 3, can generate a data write request including data, such as data 140 of FIGS. 1-2. At 720, the host computer system can provide the data write request to a CSD of the storage system, such as CSD 110 of FIGS. 1-2, CSD 400 of FIG. 4, CSD 510 of FIG. 5, and CSD 610 of FIG. 6, by way of a bus such as bus 120, 306, 520, 620 described above.

At 730, the CSD can determine whether to make a data placement determination based on the data write request and a policy stored by the CSD. In some examples, the CSD can execute an application program, such as application program 334 of FIG. 3, to determine placement of the data. That is, the application program of the CSD can include a policy that aligns with an application program of the host computer system to determine placement of data in the storage system. Therefore, at 740, the CSD can determine data placement of the data in the data write request if the CSD determines that data write request does not include a data placement determination. In other examples, the application program of the host computer system can include a policy to determine placement of the data in the storage system. Therefore, the data write request can include the data placement determination if the host computer system determines data placement. Accordingly, the CSD does not need to determine placement of data if the data placement determination is provided with the data write request.

At 750, the CSD calculates parity for the data of the write request and generates a parity block for the data. At 760, the CSD can stripe the data into blocks of data. At 770, the CSD can write the parity block and blocks of data to a storage volume, which can include at least one partition of a plurality of SSDs (e.g., SSDs 130 of FIGS. 1-3, SSDs 530 of FIG. 5, and SSDs 630 of FIG. 6).

What is claimed is:

1. A system comprising:
a host computer system;
a host system bus coupled to the host computer system;
one or more storage devices coupled to the host system bus and configured to store data;
a computational storage device (CSD) coupled to the host system bus and configured to receive a data write request comprising data from the host computer system, the CSD comprising:
a memory; and
an application processor configured to write the data of the data write request to the one or more storage devices in response to receiving the data write request.

2. The system of claim 1, wherein the one or more storage devices are solid state drives (SSDs).

3. The system of claim 2, wherein the CSD stripes the data into one or more blocks of data in response to receiving the data write request.

4. The system of claim 3, wherein the CSD generates a parity block of data by calculating parity for the data of the data write request in response to receiving the data write request.

5. The system of claim 4, wherein data write request further comprises a determination of data placement by the host system that indicates a storage device of the one or more storage devices to store each of the one or more blocks of data and the parity block of data.

6. The system of claim 4, wherein the CSD determines data placement among the one or more storage devices, the data placement determination indicating a storage device of the one or more storage devices to store each of the one or more blocks of data and the parity block of data.

7. The system of claim 6, wherein the CSD stores the parity block of data in the memory of the CSD in response to generating the parity block of data and in compliance with the data placement determination.

8. The system of claim 7, wherein the CSD stores the parity block of data in a storage device of the one or more storage devices in response to generating the parity block of data in compliance with the data placement determination.

9. The system of claim 8, wherein the data write request is a first data write request and the CSD is a first CSD of a plurality of CSDs coupled to the host system bus, and the first CSD stores the parity block of data and blocks of data corresponding to the first data write request in a first storage volume that includes a partition of the one or more storage devices.

10. The system of claim 9, further comprising a second CSD of the plurality of CSDs that receives a second data write request, wherein the second CSD generates a second parity block for a second set of data, stripes the second set of data into a second set of blocks, and stores the second parity block and second set of blocks in the first storage volume in response to receiving the second write request.

11. The system of claim 10, further comprising a third CSD of the plurality of CSDs that receives a third data write request, such that the third CSD generates a third parity block for a third set of data, stripes the third set of data into a third set of blocks, and stores the third parity block and third set of blocks in a second storage volume in response to receiving the third data write request that comprises the third set of data, wherein the second storage volume is another partition of the one or more storage devices.

12. The system of claim 11, wherein the first CSD retrieves the first set of blocks and parity bit from the first storage volume in response to receiving a read request.

13. The system of claim 12, wherein the plurality of storage devices and plurality of CSDs communicate with Non-Volatile Memory express-over-Fabrics (NVMe-oF) using Remote Direct Memory Access (RDMA), Fibre Channel (FC), or (TCP/IP).

14. A system comprising:
a host computer system including a host system bus adaptor that allows the host computer system to communicate over a network;
a host system bus coupled to the host computer system;
one or more storage devices coupled to the host system bus to communicate with the host computer system over the network;
one or more storage volumes, each storage volume having memory space partitioned in at least one of the one or more SSDs; and
one or more computational storage devices (CSDs) configured to receive a data write request comprising data from the host computer system, each CSD corresponding to a storage volume of the one or more storage volumes and each CSD comprising:
a memory; and
an application processor configured to generate a parity block for the data, stripe the data into one or more blocks of data, and store the parity block and one or more blocks of data in the corresponding storage volume.

15. The system of claim 14, wherein the memory of a given CSD of the one or more CSDs contributes to a given storage volume of the one or more storage volumes corresponding to the given CSD.

16. The system of claim 14, wherein the one or more storage devices and one or more CSDs communicate with Non-Volatile Memory express-over-Fabrics (NVMe-oF) using Remote Direct Memory Access (RDMA), Fibre Channel (FC), or (TCP/IP).

17. A method for storing data, the method comprising:
generating, by a host computer system, a first data write request including a first set of data;
providing, via a host system bus, the first data write request to a first computational storage device (CSD), the CSD comprising:
an application processor; and
a memory;
generating, by the first CSD, a first parity block for the first set of data in response to receiving the first data write request;
striping, by the first CSD, the first set of data into a first set of blocks in response to receiving the first data write request; and
storing, by the first CSD, the first parity block and first set of blocks in a first storage volume in response to striping the first set of data, the first storage volume comprising one or more storage devices coupled to the host system bus.

18. The method of claim 17, wherein the host computer system includes a host bus adapter, such that the host system bus is over network.

19. The method of claim 18, further comprising determining, by the first CSD, data placement of the first parity block and first set of blocks in the plurality of SSDs of the corresponding first storage volume.

20. The method of claim 19, further comprising:
generating, by the host system, a second data write request including a second set of data;
providing, via the host system bus, the second data write request to a second CSD;
calculating, by the second CSD, a parity block for the second set of data in response receiving the second data write request;
striping, by the second CSD, the second set of data into a second set of blocks in response to receiving the second data write request; and
storing, by the second CSD, the parity block for the second set of data and the second set of blocks in a second storage volume in response to striping the second set of data, the second storage volume comprising the one or more storage devices coupled to the host system bus.

21. A computational storage device (CSD) comprising:
an interface configured to couple the CSD to a host system bus, wherein the CSD receives a data write request via the interface;
an application processor; and
a memory configured to store an application program executable by the application processor for:
calculating a parity block for data of the data write request in response to receiving the data write request;
striping the data into a set of blocks; and
distributing the set of blocks and the parity block across one or more storage devices coupled to the to the host system bus via the interface.

22. The CSD of claim 21, wherein the one or more storage devices are configured as a storage volume.

23. The CSD of claim 22, wherein the storage volume further comprises the memory of the CSD.

24. The CSD of claim 22, wherein the storage volume is one of multiple storage volumes defined by the one or more storage devices.

25. The CSD of claim 24, wherein the data write request further comprises a determination of data placement for the set of blocks and the parity block among the storage volume.

26. The CSD of claim 24, wherein the application program is further executable by the processor to determine placement of the set of blocks and the parity block among the storage devices of the storage volume.

27. A storage system for coupling to a host computer system via a host system bus, the storage system comprising:
one or more storage devices;
one or more storage volumes, each storage volume having memory space partitioned in at least one of the one or more storage devices;
one or more computational storage devices (CSDs) configured to receive a data write request comprising data, each CSD comprising:
an interface configured to couple to the one or more storage devices;
a memory configured to store an application program for:
generating a parity block for the data;
striping the data into one or more blocks of data; and
writing the parity block and the one or more blocks of data to a corresponding storage volume; and
an application processor configured to execute the application program.

28. The storage system of claim 27, wherein the memory of a given CSD of the one or more CSDs contributes to a given storage volume of the one or more storage volumes corresponding to the given CSD.

29. The storage system of claim 28, wherein data write request further comprises a data placement determination for the parity block and the one or more blocks of data among the corresponding storage volume.

30. The storage system of claim 28, wherein the application program further comprises determining placement of the parity block and one more blocks of data among the corresponding storage volume.

31. The storage system of claim 28, wherein the one or more storage devices and one or more CSDs communicate with Non-Volatile Memory express-over-Fabrics (NVMe-oF) using Remote Direct Memory Access (RDMA), Fibre Channel (FC), or (TCP/IP).

32. A storage system comprising:
a plurality of computational storage devices (CSDs), a given CSD comprising:
an interface configured to couple to at least one other CSD and to receive a data write request including data;
a partitioned memory, wherein a first partition contributes to a first storage volume controlled by the given CSD and a second partition contributes to a second storage volume controlled by at least one other CSD; and
an application processor configured to execute an application program stored in the memory of the given CSD, the application program comprising machine executable instructions for:
generating a parity block for the data;
striping the data into one or more blocks of data; and
writing the parity block and the one or more blocks of data to the first storage volume.

33. The storage system of claim 32, wherein the machine executable instructions further comprise determining placement of the parity block and one or more blocks of data among the first storage volume.

34. The storage system of claim 32, wherein the data write request further comprises a data placement determination for the parity block and one or more blocks of data among the first storage volume.
